(19) United States
(12) Patent Application Publication
(10) Pub. No.: US 2023/0161079 A1
(43) Pub. Date: May 25, 2023

(54) OPTICAL LAMINATE AND FLEXIBLE DISPLAY DEVICE INCLUDING THE SAME

(71) Applicant: LG CHEM, LTD., Seoul (KR)

(72) Inventors: Myoungseok CHO, Daejeon (KR); Seung Joon LIM, Daejeon (KR); Yoon Bin LIM, Daejeon (KR); Eun Seon LEE, Daejeon (KR); Yeongkyu CHOI, Daejeon (KR); Gieun PARK, Daejeon (KR)

(73) Assignee: LG CHEM, LTD., Seoul (KR)

(21) Appl. No.: 17/996,851

(22) PCT Filed: Nov. 30, 2021
(86) PCT No.: PCT/KR2021/017849

§ 371 Date: Oct. 21, 2022

(30) Foreign Application Priority Data
Dec. 23, 2020 (KR) 10-2020-0181985
Nov. 23, 2021 (KR) 10-2021-0162577

(51) Int. Cl. G02B 1/14; C08G 77/14; C08J 7/046; C08J 7/04

(52) U.S. Cl. CPC G02B 1/14; C08G 77/14; C08J 7/046; C08J 7/042

(57) ABSTRACT

This invention relates to an optical laminate comprising: a hard coating layer comprising polysiloxane; a primer layer; and an anti-finger print layer comprising a fluorine-containing compound, and having specific change in water contact angle and specific change in coefficient of friction, before and after conducting friction test on the anti-finger print layer; and a flexible display device including the same.

### CROSS-REFERENCE TO RELATED APPLICATION(S)

This application is a 35 U.S.C. 371 National Phase Entry Application from PCT/KR2021/017849 filed on Nov. 30, 2021, which claims the benefit of Korean Patent Application No. 10-2020-0181985 filed on Dec. 23, 2020 and Korean Patent Application No. 10-2021-0162577 filed on Nov. 23, 2021 with the Korean Intellectual Property Office, the disclosures of which are herein incorporated by reference in their entirety.

### FIELD OF THE INVENTION

This invention relates to an optical laminate and a flexible display device including the same.

### BACKGROUND OF THE INVENTION

Recently, with the development of mobile devices such as a smart phone and table PC, a substrate for display is required to be made thin and slim. On the window or front panel for display of a mobile device, glass or tempered glass having excellent mechanical properties are generally used. However, their own weights of the glass and tempered glass are heavy, thus increasing the weight of a mobile device, and they are easily damaged by external impact, and due to low flexibility, the application for flexible or foldable display devices are limited. And, an anti-finger print layer is coated on glass to give anti-fouling property on the window or front panel for display, but adhesion between the glass and anti-finger print layer is low, and thus, durability such as scratch resistance is low.

As material for replacing glass, plastic resin is being studied. The plastic resin is light-weighed, is not easily broken, and has flexibility, and thus, is more suitable for light-weighted and flexible mobile devices. Representatively, polyethyleneterephthalate(PET), polyethersulfone(PES), polyethylenenaphthate(PEN), polyacrylate(PAR), polycarbonate(PC), polyimide(PI), polyamideimide(PAI), and the like are used, but substrates using these plastic resins have insufficient hardness and scratch resistance, compared to glass. Thus, there are attempts to supplement high hardness and abrasion resistance by coating a resin composition on the plastic resin substrate to form a hard coating layer.

For example, for hard coating of a foldable display substrate, UV curable acrylate-based resin is mainly used. However, since the acrylate-based resin has high shrinkage during curing and thus seriously generates curl, thin coating should be progressed, and thus, impact resistance is low.

And, sometimes, anti-finger print additives are added on a resin composition for a hard coating layer to give anti-fouling property to the window or front panel for display, but hardness and anti-fouling property of a coating layer are in trade-off relationship, and thus, it is required to secure technology meeting both properties.

### BRIEF SUMMARY OF INVENTION

The invention provides an optical laminate that has improved adhesive force and scratch resistance, as well as excellent anti-fouling property and high hardness, and thus, can replace a tempered glass cover window, is not substantially damaged even by repeated bending or folding, and thus, can be easily applied for bendable, flexible, rollable, or foldable mobile devices or display devices.

The invention also provides a flexible display device including the optical laminate.

There is provided herein an optical laminate comprising: a hard coating layer comprising polysiloxane; a primer layer; and an anti-finger print layer comprising a fluorine-containing compound, wherein water contact angle on the surface of the anti-finger print layer is 100° or more, before and after 1000 times reciprocating abrasion of steel wool under load of 500 g on the surface of the anti-finger print layer, change in water contact angle of the surface of the anti-finger print layer is 10° or less, and before and after 1000 times reciprocating abrasion of steel wool under load of 500 g on the surface of the anti-finger print layer, change in coefficient of friction of the surface of the anti-finger print layer is 0.2 or less.

There is also provided herein a flexible display device including the optical laminate.

### DETAILED DESCRIPTION INVENTION

Hereinafter, an optical laminate and a flexible display device including the same according to specific embodiments of the invention will be explained in detail.

As used herein, “flexible” means having flexibility to such a degree that cracks with length of 3 mm or more may not be generated when wound in a cylindrical mandrel having a diameter of 3 mm, and thus, the optical laminate can be applied as a cover film of bendable, flexible, rollable, or foldable display.

And, as used herein, “(meth)acrylate” includes both acrylate and methacrylate.

And, as used herein, “(meth)acryloxy group” includes both acryloxy group and methacryloxy group.

And, as used herein, a “fluorine-containing compound” means a compound containing one or more fluorine atoms(F).

And, as used herein, an “organic silane compound” or a “modified silane compound” includes not only organic silane compounds, but also partial hydrolysis condensation products thereof.

And, as used herein, curing includes both photocuring and thermal curing.

Throughout the specification, weight average molecular weight means polystyrene-converted weight average molecular weight measured by GPC. During the process of measuring polystyrene-converted weight average molecular weight by GPC, commonly known analysis devices, detectors such as refractive index detector, and analysis columns may be used, and commonly applied temperature condition, solvent and flow rate may be applied. For example, Polymer Laboratories PLgel MIX-B 300 mm length column and Waters PL-GPC220 device are used, evaluation temperature is 160° C., 1,2,4-trichlorobenzne is used as a solvent, and flow rate is 1 mL/min. And, a sample is prepared at the concentration of 10 mg/10 mL, and then, fed in an amount of 200 μL. And, using a calibration curb formed with polystyrene standard, Mw value can be calculated. As the polystyrene standard, 9 kinds respectively having weight average molecular weight of 2,000/10,000/30,000/70,000/200,000/700,000/2,000,000/4,000,000/10,000,000 are used.

And, as used herein, the term “substituted or unsubstituted” means being unsubstituted or substituted with one or more selected from the group consisting of deuterium; halogen; nitrile; nitro; hydroxy; carbonyl; ester; imide; amino; phosphine oxide; alkoxy; aryloxy; alkylthioxy; arylthioxy; alkylsulfoxy; arylsulfoxy; silyl; boron; alkyl; cycloalkyl; alkenyl; aryl; aralkyl; aralkenyl; alkylaryl; alkylamine; aralkylamine; heteroarylamine; arylamine; arylphosphine; or heterocyclic group comprising one or more selected from N, O and S, or being unsubstituted or substituted with a substituent wherein two or more substituents of the above exemplified substituents are connected. For example, “a substituent wherein two or more substituents are connected” may be a biphenyl group. Namely, the biphenyl group may be an aryl group, and it may be interpreted as a substituent wherein two phenyl groups are connected.

According to one embodiment of the invention, there is provided an optical laminate comprising: a hard coating layer comprising polysiloxane; a primer layer; and an anti-finger print layer comprising a fluorine-containing compound, wherein water contact angle on the surface of the anti-finger print layer is 100° or more; before and after 1000 times reciprocating abrasion of steel wool under load of 500 g on the surface of the anti-finger print layer, change in water contact angle of the surface of the anti-finger print layer is 10° or less; and before and after 1000 times reciprocating abrasion of steel wool under load of 500 g on the surface of the anti-finger print layer, change in coefficient of friction of the surface of the anti-finger print layer is 0.2 or less.

The inventors progressed studies on optical laminates that can be applied for cover windows of flexible display devices, and confirmed that in case an optical laminate having a multilayer structure comprises a primer layer and an anti-finger print layer comprising a fluorine-containing compound on a hard coating layer having a specific composition, wherein water contact angle on the surface of the anti-finger print layer is 100° or more; and before and after 1000 times reciprocating abrasion of steel wool under load of 500 g on the surface of the anti-finger print layer, change in water contact angle of the surface of the anti-finger print layer is 10° or less; and before land after 1000 times reciprocating abrasion of steel wool under load of 500 g on the surface of the anti-finger print layer, change in coefficient of friction of the surface of the anti-finger print layer is 0.2 or less, interlayer adhesion may be excellent, and thus, damage such as abrasion due to external impact may be prevented, and remarkably excellent scratch resistance and abrasion resistance may be exhibited, and simultaneously, excellent water repellent and oil repellent properties may be realized, thus realizing excellent fouling property and touch (slip property), and completed the invention.

And, the optical laminate is not substantially damaged even by repeated bending or folding, and thus, specifically, with the hard coating layer or anti-finger print layer being inside, when continuous movement of folding and unfolding both sides at 90 degree angle such that diameter of curvature becomes 3 mm, are repeatedly conducted 200,000 times, it exhibits bending durability to such degree that cracks of 3 mm or more may not be generated.

Specifically, water contact angle on the surface of the anti-finger print layer included in the optical laminate may be 100° or more, 105° or more, 110° or more, or 115° to 150°. Since water contact angle of the surface of the anti-finger print layer is 100° or more, excellent water repellent and oil repellent properties may be realized, thus realizing excellent anti-fouling property and slip property. Meanwhile, if water contact angle of the surface of the anti-finger print layer is less than 100°, water repellent and oil repellent properties may be deteriorated, and thus, fouling resistance and scratch resistance may be lowered.

Meanwhile, after 1000 times reciprocating abrasion of steel wool under load of 500 g on the surface of the anti-finger print layer, change in water contact angle of the surface of the anti-finger print layer may be 10° or less, 9° or less, 8° or less, 7° or less, or 5° to 0.1°. Since change in water contact angle of the anti-finger print layer before and after reciprocating abrasion of steel wool is 10° or less, even if a part of the surface is modified due to external rubbing or friction, change in water contact angle is small, and thus, excellent water repellent and oil repellent properties may be maintained, thus exhibiting excellent anti-fouling property and slip property. If the change in water contact angle is greater than 10°, a degree of decrease in durability according to use time may increase, and thus, excellent anti-fouling property and slip property may not be maintained.

Meanwhile, after 1000 times reciprocating abrasion of steel wool under load of 500 g on the surface of the anti-finger print layer, water contact angle of the surface of the anti-finger print layer may be greater than 100°, 101° or more, 102° or more, 102° to 160°, 103° to 150°, or 104° to 130°.

And, after 1000 times reciprocating abrasion of steel wool under load of 500 g on the surface of the anti-finger print layer, change in coefficient of friction of the surface of the anti-finger print layer may be 0.20 or less, 0.01 to 0.19, 0.01 to 0.18, 0.05 to 0.17, or 0.05 to 0.15. The coefficient of friction may be coefficient of static friction measured according to ASTM D1894 using a friction tester (Toyoseiki, Model TR type) for the anti-finger print layer.

Since the anti-finger print layer has change in coefficient of friction before and after reciprocating abrasion of steel wool of 0.20 or less, even if a part of the surface is modified by external rubbing or friction, change in coefficient of friction is small, and thus, excellent water repellent and oil repellent properties may be maintained, thus exhibiting excellent anti-fouling property and slip property. If the change in coefficient of friction is greater than 0.20, a degree of decrease in durability according to use time may increase, and thus, excellent anti-fouling property and slip property may not be maintained.

The hard coating layer included in the optical laminate according to one embodiment may comprise polysiloxane comprising 70 mol % or more of repeat units comprising epoxy group-containing functional groups, and elastic polymer.

Meanwhile, the epoxy group-containing functional group is not specifically limited as long as it comprises an epoxy group, but for example, it may be one selected from the group consisting of alicyclic epoxy groups and functional groups represented by the following Chemical Formula 1.

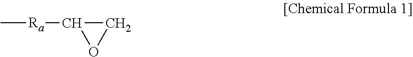

in the Chemical Formula 1,

Rₐ is a substituted or unsubstituted C1-6 alkylene group, a substituted or unsubstituted C2-20 alkenylene group, a substituted or unsubstituted C2-20 alkynylene group, —R_{b}—CH═CH—COO-R_{c}—, —R_{d}—OCO—CH═CH-Rₑ—, —R_{f}OR_{g}—, —RₕCOORᵢ—, or —RⱼOCORₖ—, and

R_{b} to Rₖ are each independently, a single bond; or a substituted or unsubstituted C1-6 alkylene group.

Since the functional group represented by the Chemical Formula 1 comprises an epoxy group, it may improve high hardness and scratch resistance of an optical laminate, and the film is not substantially damaged even by repeated bending or folding, and thus, it can be easily applied for bendable, flexible, rollable or foldable mobile devices or display devices, and the like.

For example, the epoxy group-containing functional group represented by the Chemical Formula 1 may be those wherein Rₐ is methylene, ethylene, propylene, allylene, —R_{b}—CH═CH—COO-R_{c}—, —R_{d}—OCO—CH═CH-Rₑ—, —R_{f}OR_{g}—, —RₕCOORᵢ—, or —RⱼOCORₖ—.

For example, in the Chemical Formula 1, R_{b} to Rₖ may be a single bond, methylene, ethylene, propylene, or butylene.

For example, Rₐ may be methylene, ethylene, or —R_{f}OR_{g}—, wherein R_{f} and R_{g} may be a direct bond, methylene or propylene.

For example, the functional group represented by the Chemical Formula 1, although not limited hereto, may be a glycidoxy, glycidoxy ethyl, glycidoxy propyl, or glycidoxy butyl group.

And, the alicyclic epoxy group, although not limited hereto, may be an epoxycyclohexyl group.

And, the polysiloxane may be represented by the following Chemical Formula 2.

(R¹SiO_{3/2})ₐ (R²SiO_{3/2})_{b}(O_{1/2}R)_{c} [Chemical Formula 2]

in the Chemical Formula 2,

R¹ is the epoxy group-containing functional group, provided that repeat units comprising the substituent R¹ are included in the content of 70 mol % or more, based on the total molar content of the Chemical Formula 2

R² is a substituted or unsubstituted C1-20 alkyl group, a substituted or unsubstituted C3-20 cycloalkyl group, a substituted or unsubstituted C2-20 alkenyl group, a substituted or unsubstituted C2-20 alkynyl group, a substituted or unsubstituted C6-20 aryl group, a substituted or unsubstituted C7-20 arylalkyl group, a substituted or unsubstituted C7-20 alkylaryl group, an epoxy group, a hydrogen atom, an amino group, a mercapto group, an ether group, an ester group, a carbonyl group, a carboxyl group, a (meth)acrylate or sulfone group,

R is a hydrogen atom or a C1-20 alkyl group,

a/(a+b)≥0.7,

a is a positive number,

b and c are each independently, 0 or a positive number.

The polysiloxane represented by the Chemical Formula 2 comprises a silsesquioxane unit of (R¹SiO_{3/2}) as T3 monomers.

In the silsesquioxane unit of (R¹SiO_{3/2}), R¹ is a functional group represented by the Chemical Formula 1, and may be included in the content of 70 mol % or more, 70 to 99 mol %, or 80 to 90 mol %, or 50 to 70 mol %, based on the total molar content of the Chemical Formula 2. If the content of the functional group represented by the Chemical Formula 1 is less than 70 mol %, due to decrease in cure density, it may be difficult for the upper and lower coating layers to exhibit sufficient surface hardness.

And, the polysiloxane may further comprise a silsesquioxane unit of (R²SiO_{3/2}) as T3 monomers, in addition to the above explained silsesquioxane unit of (R¹SiO_{3/2}). The silsesquioxane unit of (R²SiO_{3/2}) may increase cure density of polysiloxane, thereby improving surface hardness of the hard coating layer.

Specifically, R² may be selected from the group consisting of a substituted or unsubstituted C1-10 alkyl group, a substituted or unsubstituted C3-12 cycloalkyl group, a substituted or unsubstituted C6-12 aryl group, a substituted or unsubstituted C7-12 arylalkyl group, a substituted or unsubstituted C7-12 alkylaryl group, an epoxy group, and hydrogen atom. Among them, R² may be more specifically a C1-6 alkyl group or C6 aryl group, or an epoxy group, unsubstituted or substituted with one or more selected from the group consisting of acryl, methacryl, vinyl, allyl, epoxy and oxetane groups, in that cure density may be further increased to further improve surface hardness of the hard coating layer. Meanwhile, the epoxy group is a functional group comprising an oxirane ring, and includes an alicyclic epoxy group, an aliphatic epoxy group, and an aromatic epoxy group, but excludes the epoxy group-containing functional group represented by the Chemical Formula 1.

Meanwhile, the polysiloxane may comprise a constructional unit of (O_{1/2}R). By including the constructional unit, flexibility may be improved while maintaining excellent hardness. R may be specifically, a hydrogen atom, or a C1-12 alkyl group, and more specifically, a hydrogen atom, or a C1-4 linear or branched alkyl group such as methyl, ethyl, propyl, isopropyl, butyl, isobutyl, and the like.

The polysiloxane comprising the above explained constructional units may be prepared by hydrolysis and condensation of slioxane monomers of each constructional unit, specifically, alkoxysilane having the functional groups of the Chemical Formula 1 alone, or between alkoxysilane having the functional group of the Chemical Formula 1 and a different kind of alkoxysilane, wherein mole ratio of each constructional unit can be controlled through the control of content ratio of alkoxysilane. Specifically, in the Chemical Formula 2, a, b and c respectively represents the mole ratio of (R¹SiO_{3/2}) unit, (R²SiO_{3/2}) unit, and (O_{1/2}R) unit constituting the polysiloxane, wherein 0<a<1, 0≤b<1 and 0≤c<1.

And, the polysiloxane comprises the constructional unit (R¹SiO_{3/2}) in the content of 70 mol % or more, more specifically 70 mol % to 100 mol %, based on the total amount, i.e., 100 mol % of T monomers constituting the polysiloxane, while satisfying each content range of the above explained constructional unit, and thus, cure density may increase when forming a hard coating layer, and as the result, the optical laminate may exhibit remarkably improved surface hardness (when indicated as a mole ratio, 0.7≤a/(a+b)≤1). If the molar content of the constructional unit (R¹SiO_{3/2}) in the polysiloxane is less than 70 mol %, due to decrease in cure density, it may be difficult for the upper and lower coating layer to exhibit sufficient surface hardness. More specifically, the constructional unit (R¹SiO_{3/2}) may be included in the content of 70 mol % or more and less than 85 mol %, or 85 mol % or more and less than 100 mol %, based on the total amount, i.e., 100 mol % of T monomers.

And, in case the polysiloxane further comprises the constructional unit (R²SiO_{3/2}), it may be included at the mole ratio corresponding to b(0<b<1), and more specifically, the constructional unit (R²SiO_{3/2}) may be further included at the mole ratio meeting 0<b<0.5 or 0.01≤b≤0.5, even more specifically 0.1≤b≤0.3. If the constructional unit (R²SiO_{3/2}) is included in the above content range, cure density of polysiloxane may be increased to improve surface hardness of the hard coating layer.

And, in case the polysiloxane further comprise the constructional unit (O_{1/2}R), it may be included at the mole ratio corresponding to c (0<c<1), and more specifically, the (O_{1/2}R) unit may be included at the mole ratio meeting 0<c<0.5, even more specifically 0.01≤c≤0.3 or 0.01≤c≤0.05. In case the (O_{1/2}R) unit is included in the above content range, flexibility may be improved while maintaining excellent hardness.

And, while the above content ranges are met, the sum (a+b+c) of the mole fractions of the constructional units included in the polysiloxane may be 1. Meanwhile, the content of each constructional unit constituting the polysiloxane may be obtained by ¹H-NMR or ²⁹Si-NMR spectrum measurement.

Meanwhile, the polysiloxane may have epoxy group-containing functional group equivalent of 3.0 to 6.3 mmol/g or 4.0 to 6.0 mmol/g. If the equivalent of the functional group represented by the Chemical Formula 1 is too small, density of the hard coating layer may decrease, and surface hardness may be lowered, and if it is too large, flexibility may be lowered, and un-cured epoxy groups may remain, thus deteriorating environmental reliability. The equivalent of functional group is a value obtained by dividing the molecular weight of polysiloxane with the number of functional groups, and may be analyzed by H-NMR or chemical titration.

And, when preparing the polysiloxane, weight average molecular weight, number average molecular weight, molecular weight distribution, and the like can be controlled through control of reaction speed by reaction temperature, the amount and kind of catalyst, solvent, and the like, and the above explained polysiloxane may have weight average molecular weight of 1,000 to 50,000 g/mol, or 1,200 to 15,000 g/mol. Within the above range of weight average molecular weight, excellent hardness may be exhibited. If weight average molecular weight is less than 1,000 g/mol, hardness may not be realized, and softness may be exhibited to the contrary, and if it is greater than 50,000 g/mol, although high hardness may be exhibited, film processability may be deteriorated.

And, the polysiloxane may have number average molecular weight (Mn) of 1,000 to 10,000 g/mol, more specifically 1,000 to 8,000 g/mol, in addition to the above explained Mw. In case the number average molecular weight condition is met, compatibility with other components in the resin composition for forming a hard coating layer may increase, and surface hardness of the cured product may be improved, and thus, heat resistance and abrasion resistance of the cured product may be further improved. Meanwhile, the weight average molecular weight and number average molecular weight of polysiloxane are standard polystyrene-converted values by gel permeation chromatography.

And, the polysiloxane may have molecular weight distribution (Mw/Mn) of 1.0 to 10.0, more specifically 1.1 to 5.0. Within the above range of molecular weight distribution, surface hardness improvement effect may be more excellent, and the polysiloxane may exist as liquid, and thus, can be easily handled.

The hard coating layer included in the optical laminate according to one embodiment comprises elastic polymer. The elastic polymer may give stress resistance through toughness of the hard coating layer, thus minimizing shrinkage during curing, and as the result, improve bending property, and simultaneously, improve flexibility, and hardness property.

The content of the elastic polymer included in the hard coating layer may be specifically, 20 to 80 parts by weight, 30 to 75 parts by weight, 35 to 70 parts by weight, 40 to 65 parts by weight, based on 100 parts by weight of polysiloxane comprising 70 mol % or more of repeat units comprising the epoxy group-containing functional groups. If the content of the elastic polymer is too large, surface hardness may be lowered, and if the content of the elastic polymer is too small, improvement effect according to the inclusion of the elastic polymer may not be sufficiently obtained, and there is concern about deterioration of bending property and flexibility.

The elastic polymer, although not limited hereto, may comprise one or more selected from the group consisting of C1-20 alkanediol, polyolefin polyol, polyester polyol, polycaprolactone polyol, polyether polyol and polycarbonate polyol. These elastic polymers, compared to common elastic polymers such as rubber, may be crosslinked by UV irradiation, and may realize high hardness and flexibility without deterioration of other properties.

Among them, the elastic polymer may comprise polycaprolactone diol, polycarbonate diol, or mixtures thereof, and particularly, the polycaprolactone diol simultaneously comprises an ester group and an ether group in the repeat unit, and thus, when used in combination with the polysiloxane, excellent effect in terms of impact resistance may be exhibited.

The elastic polymer may have number average molecular weight (Mn) of 500 to 10,000 Da, or 530 to 5,000 Da. In case the above number average molecular weight condition is met, compatibility with other components in the hard coating layer may increase, and surface hardness of the cured product may be improved, and thus, heat resistance and abrasion resistance of the cured product may be further improved.

The hard coating layer included in the optical laminate according to one embodiment may further comprise reactive monomers comprising one or more functional groups that can be crosslinked with the polysiloxane. Since the reactive monomers comprise one or more functional groups that can be crosslinked with the above explained polysiloxane, they function as a crosslinking agent in the polysiloxane network, thereby increasing tensile strength of the hard coating layer.

The reactive monomers may comprise one or more selected from the group consisting of an alicyclic epoxy group, a glycidyl group and an oxetany group, as the functional group that can be crosslinked with the polysiloxane.

And, the reactive monomers comprising one or more functional groups that can be crosslinked with the polysiloxane may comprise, for example, one or more selected from the group consisting of bisphenol A diglycidyl ether, 4-vinylcyclohexene dioxide, cyclohexene vinyl monoxide, (3,4-epoxycyclohexyl)methyl, 3,4-epoxycylcohexylcarboxylate, 3,4-epoxycyclohexylmethyl methacrylate, 3,4-epoxycyclohexanecarboxylate, 2-(3,4-epoxycyclohexyl)-1,3-dioxolane, bis(3,4-epoxycyclohexylmethyl)adipate, p-butyl phenol glycidyl ether, butyl glycidyl ether, cresyl glycidyl ether, allkyl glycidyl ether, phenyl glycidyl ether, diglycidyl ether, butanediol diglycidyl ether, limonene dioxide, diethylene glycol diglycidyl ether, 3-methyloxetane, 2-methyloxetane, 3-oxetanol, 2-methylene oxetane, 3-methyl hydroxymethyloxetane, 3-ethyl-3-hydroxymethyloxetane, 3,3-oxetane dimethanethiol, 2-ethylhexyl oxetane, 4-(3-methyloxetan-3-yl)benzonitrile, N-(2-2-dimethylpropyl)-3-methyl-3-oxetane methaeamine, N-(1,2-dimethylbutyl)-3-methyl-3-oxetane methaneamine, xylene bis oxetane, 3-ethyl-3[{(3-ethyloxetan-3-yl)methoxy}methyl]oxetane, (3-ethyloxetan-3-yl)methyl methacrylate, and 3[(ethyloxetan-3yl)methoxy]butan-1-ol.

The weight ratio of the polysiloxane and reactive monomers included in the hard coating layer may be 99:1 to 70:30, 95:5 to 72:28, 90:10 to 74:26, or 80:20 to 75:25. If the content of the polysiloxane is too large compared to the reactive monomers, improvement effect according to the inclusion of the reactive monomers may be insignificant. Meanwhile, if the content of the polysiloxane is too small compared to the elastic polymer, due to the excessive amount of reactive monomers, distance between cure sites may become narrow, and thus, due to cure shrinkage, internal stress of the coating layer may increase, and crack resistance may decrease.

The hard coating layer may further comprise an acrylate-based compound so as to improve surface hardness.

As the acrylate-based compound, 2-ethylhexyl acrylate, octadecyl acrylate, isodecyl acrylate, 2-phenoxyethyl acrylate, lauryl acrylate, stearyl acrylate, behenyl acrylate, tridecyl methacrylate, nonylphenolethoxylate monoacrylate, β-carboxyethyl acrylate, isobornyl acrylate, tetrahydrofurfuryl acrylate, tetrahydrofurfuryl acrylate, 4-butylcyclohexyl acrylate, dicyclopentenyl acrylate, dicyclopentenyl oxyethyl acrylate, ethoxyethoxyethyl acrylate, ethoxylated monoacrylate, 1,6-hexanedioldiacrylate, triphenylglycol diacrylate, butanediol diacrylate, 1,3-butyleneglycol dimethacrylate, 1,6-hexanediol dimethacrylate, neopentylglycol diacrylate, ethyleneglycol dimethacrylate, diethyleneglycol diacrylate, diethyleneglycol dimethacrylate, tetraethyleneglycol diacrylate, tetraethyleneglycol dimethacrylate, triethyleneglycol diacrylate, triethyleneglycol dimethacrylate, polyethyleneglycol diacrylate, polyethyleneglycol dimethacrylate, dipropyleneglycol diacrylate, ethoxylated neopentylglycol diacrylate, trimethylolpropane triacrylate, trimethylolpropane trimethacrylate, pentaerythritol triacrylate, pentaerythritol trimethacrylate, pentaerythritol tetramethacrylate, pentaerythritol tetraacrylate, ethoxylated triacrylate, tris(2-hydroxyethyl)isocyhanurate triacrylate, dipentaerythritol pentacrylate, ditrimethylolpropane tetraacrylate, alkoxylated tetraacrylate, and the like may be mentioned, and preferably, multifunctional acrylate-based compounds, such as pentaerythritol triacrylate, pentaerythritol trimethacrylate, pentaerythritol tetramethacrylate, or pentaerythritol tetraacrylate, and the like may be mentioned, and one or mixture thereof may be used.

Besides, acrylate-based oligomers, such as polyester acrylate, polyether acrylate, urethane acrylate, or epoxy acrylate, and the like may be mentioned, and one or mixtures thereof may be used. Among the acrylate-based compounds, considering remarkable surface hardness improvement effect during use in combination with the above explained polysiloxane, urethane acrylate oligomer may be more preferably used.

The urethane acrylate oligomer may have a functional group number of 6 to 9. If the number of functional groups is less than 6, hardness improvement effect may be insignificant, and if it is greater than 9, hardness may be excellent, but viscosity may increase. And, as the urethane (meth)acrylate oligomer, those used in the art may be used without limitations, but preferably, those prepared by reacting a compound having one or more isocyanate groups in the molecule with a (meth)acrylate compound having one or more hydroxy groups in the molecule may be used.

In case the acrylate-based compound is further included, it may be included in the content of 0.1 to 20 parts by weight, 1 to 15 parts by weight, or 5 to 10 parts by weight, based on 100 parts by weight of the polysiloxane. If the content is less than 0.1 parts by weight, improvement effect according to the inclusion of the acrylate-based compound may be insignificant, and if it is greater than 20 parts by weight, due to excessive amount of acrylate-based compound, surface hardness improvement effect may be inhibited to the contrary.

Besides the above explained components, the hard coating layer may further comprise one or more commonly used additives, such as an antioxidant, surfactant, an anti-yellowing agent, inorganic filler, lubricant, a coating assistant, an anti-foulant, and the like.

As explained above, since the hard coating layer comprises the polysiloxane, excellent hardness and improved flexibility and being properties may be given to the optical laminate. And, on the hard coating layer, a primer layer and an anti-finger print layer may be sequentially laminated. Since the hard coating layer, primer layer and anti-finger print layer are sequentially laminated, excellent anti-fouling property, anti-finger print property, high strength and scratch resistance may be given.

Specifically, since the anti-finger print layer comprises a fluorine-containing compound, anti-fouling property and anti-finger print property of the optical laminate may be improved. And, the primer layer increases adhesion between the hard coating layer and anti-finger print layer, thereby preventing shear failure and loss of the hard coating layer and anti-finger print layer due to shear stress. Thus, the optical laminate can be applied as a cover window for display, replacing tempered glass.

And, such an optical laminate is not substantially damaged even by repeated bending or folding, and specifically, it may exhibit bending durability to such a degree that 3 mm or more cracks may not be generated when continuous movement of folding and unfolding at 90 degree such that a diameter of curvature becomes 3 mm, are conducted 200,000 times, with the hard coating layer or anti-finger print layer being inside.

FIG. 1 schematically shows a method for evaluating dynamic bending property.

Referring to FIG. 1, bending durability is measured as follows: an optical laminate is placed horizontally to the bottom, and then, both sides of the optical laminate are folded at 90 degree to the bottom surface such that a distance between folded parts in the middle of the optical laminate becomes 3 mm and unfolded, which were repeated 200,00 times at 25° C. at a speed of one time per 1.5 seconds. Wherein, in order to constantly maintain the distance between folded parts, for example, a rod having a diameter(R) of 3 mm is put on the optical laminate, and both sides of the optical laminate around the rod are folded and unfolded. And, the folded part is not specifically limited as long as it is the inside of the optical laminate, and for convenience of measurement, the middle of the optical laminate may be folded such that both sides of the optical laminate excluding the folded part may become symmetrical.

In such dynamic bending property evaluation, even after bending the optical laminate 200,000 times, cracks of 1 cm or more, or 3 mm or more are not generated, and substantially no cracks are generated. Particularly, whether the optical laminate is folded inwards or outwards, cracks are not generated, and for example, even if the anti-finger print layer of the optical laminate is folded inwards, or the hard coating layer is folded inwards, or in case a support base layer is included on one side of the hard coating layer, even if the support base layer is folded inwards, cracks are not generated. Thus, when practical used such as being repeatedly folded, rolled or bent, there is little concern about generation of cracks, and thus, the optical laminate can be appropriately applied for a cover window of a flexible display device.

A primer layer included in the optical laminate according to one embodiment may comprise an organic silane compound. The organic silane compound is a compound having a functional group acting as a silane coupling agent, and may have at least one organic functional group in one molecule. The organic functional group may be at least one selected from the group consisting of an epoxy group, a (meth)acryloxy group, a mercapto group, an amino group, a vinyl group and a ureido group. And, the organic silane compound may be a compound having at least one hydrolysable group, wherein the hydrolysable group is an alkoxy group bonded to a silicon atom.

Specifically, the organic silane compound having organic functional groups may be one or more selected from the group consisting of 2-(3,4-epoxycyclohexyl)ethyltrimethoxysilane, 3-glycidoxypropyl trimethoxysilane, 3-glycidoxypropyl methyldiethoxysilane, 3-glycidoxypropyl triethoxysilane, glycidoxypropyl methyldimethoxysilane, N-2-(aminoethyl)-3-aminopropyl methyldimethoxysilane, N-2-(aminoethyl)-3-aminopropyl trimethoxysilane, N-2-(aminoethyl)-3-aminopropyl triethoxysilane, 3-aminopropyl trimethoxysilane, 3-aminopropyl triethoxysilane, 3-ureidopropyltrimethoxysilane, 3-ureidopropyltrialkoxysilane, vinyltrimethoxysilane, vinyltriethoxysilane, methacryloxytrimethoxysilane, methacryloxytriethoxysilane, N-phenyl-γ-aminopropyl trimethoxysilane and mercaptopropyl trimethoxysilane.

The organic silane compound having organic functional groups may be included in the content of 40 to 95 wt %, 50 to 90 wt %, 60 to 85 wt %, or 70 to 80 wt %, based on total weight(100 wt %) of the primer layer. If the content of the organic silane compound is too small, due to density decrease of the primer layer, adhesive force may be lowered, and thus, scratch resistance of the optical laminate may be deteriorated, and if the content of the organic silane compound is too large, coatability may be deteriorated, and due to side reactions, haze may be generated and durability may be deteriorated.

The primer layer may further comprise one or more organic silane compounds selected from the group consisting of methyltrimethoxysilane, methyltriethoxysilane, ethyltrimethoxysilane, ethyltriethoxysilane, propyltrimethoxysilane, propyltriethoxysilane, and methyltributoxysilane, in addition to the organic silane compound having at least one organic functional group selected from the group consisting of an epoxy group, a (meth)acryloxy group, a mercapto group, an amino group, a vinyl group and a ureido group.

And, the primer layer may further comprise silica nanoparticles, aluminum oxide particles, titanium oxide particles, zinc oxide particles or polysilazane, in addition to the organic silane compounds.

And, in order to form the primer layer, a solvent may be further included. Although the kind of the solvent is not limited, preferably, it may be one or more selected from the group consisting of trifluorotoluene, chlorofluorocarbon, hydrofluorocarbon, hydrofluoroether, alcohol and C2-20 alkoxyfluoroalkane.

The primer layer may be formed by common thermal curing or photocuring after mixing the above explained components, but the curing method is not specifically limited. And, the primer layer may comprise at least one layer on the hard coating layer.

The anti-finger print layer included in the optical laminate according to one embodiment may comprise a fluorine-containing compound. The fluorine-containing compound may comprise at least one selected from the group consisting of a perfluoro polyether compound, a compound comprising an oxyperfluoroalkylene group, a fluoro-modified silane compound, and a compound comprising a fluoroalkyl group.

For example, the compound comprising an oxyperfluoroalkylene group, although not limited hereto, may be perfluoropolyethylene urethane acrylate, perfluoropolyethylene polymethacrylate, or perfluoro polymethacrylate.

And, the fluoro-modified silane compound, although not limited thereto, may be perfluoro-modified silane, perfluoropolyethylene-modified silane.

And, the compound comprising a fluoroalkyl group, although not limited hereto, may be perfluoropolyethylene.

The fluorine-containing compound may have weight average molecular weight of 300 to 200,000 g/mol, 450 to 150,000 g/mol, 480 to 130,000 g/mol, or 520 to 100,000 g/mol. If the weight average molecular weight of the fluorine-containing compound is too small, it may be difficult for the anti-finger print layer to exhibit anti-fouling property and slip property, and if the weight average molecular weight is too large, it may be difficult to exhibit scratch resistance or abrasion resistance.

The fluorine-containing compound may be included in the content of 50 wt % or more, 50 to 100 wt %, or 70 wt 99%, based on total weight (100 wt %) of the anti-finger print layer.

The anti-finger print layer may further comprise inorganic particles surface modified with silane or silazane, in addition to the fluorine-containing compound. Wherein, the inorganic particles may comprise silica nanoparticles, aluminum oxide particles, titanium oxide particles or zinc oxide particles.

And, in order to form an anti-finger print layer, a solvent may be further included. Although the kind of the solvent is not limited, preferably, it may be one or more selected from the group consisting of trifluorotoluene, chlorofluorocarbon, hydrofluorocarbon, hydrofluoroether, alcohol and C2-20 alkoxyfluoroalkane.

The anti-finger print layer may be formed by common thermal curing or photocuring after mixing the above explained components, but the curing method is not specifically limited. And, the anti-finger print layer may comprise at least one layer on the primer layer.

Meanwhile, the thickness ratio of the primer layer and anti-finger print layer included in the optical laminate may be 1:0.01 to 10,000, 1:0.05 to 100, or 1:0.1 to 500. If the thickness of the anti-finger print layer is too thin compared to the primer layer, surface modification degree may be lowered, and thus, anti-fouling property may be deteriorated, and if the thickness of the anti-finger print layer is too thick, surface hardness may be lowered, and thus, durability may be deteriorated, and hardness property of the hard coating layer in the laminate may be deteriorated.

Specifically, the primer layer may have a thickness of 1 nm to 5 μm, 10 nm to 900 nm, or 20 nm to 800 nm, and the anti-finger print layer may have a thickness of 1 nm to 20 μm, 5 nm to 10 μm, or 10 nm to 1 μm.

And, the hard coating layer may have a thickness of 10 to 100 μm, 30 to 90 μm, or 40 to 80 μm. As the thickness of the hard coating layer is thicker, the strength increases, but if the thickness is too thick, it may be easily broken when folded, and if the thickness it too thin, foldability may be secured but strength may be inferior. And, in case hard coating layers are formed on both sides of a support base layer as described later, the thicknesses of the upper hard coating layer and the lower hard coating layer may be the same or different.

The optical laminate sequentially comprises the hard coating layer, primer layer and anti-finger print layer, and may further comprise a support base layer positioned on one side of the hard coating layer so as to opposite to the primer layer. And, the optical laminate may further comprise another hard coating layer on one side of the support base layer so as to be opposite to the hard coating layer. Namely, hard coating layers may be positioned on both sides of the support base layer, and they may be distinguished as the upper hard coating layer and the lower hard coating layer.

The support base layer may have transmittance at the wavelength of 300 nm or more, of 50% or more, 75% or more, 85% or more, or 95% or more.

And, the support base layer may comprise transparent plastic resin. As specific examples of the plastic resin, polyester-based resin, cellulose-based resin, polycarbonate-based resin, acryl-based resin, styrene-based resin, polyolefin-based resin, polyimide-based resin, polyethersulfone-based resin, or sulfone-based resin, and the like may be mentioned, and one or mixtures thereof may be used.

More specifically, the support base layer may comprise at least one selected from polyethyleneterephtalate(PET), cyclic olefin copolymer(COC), polyacrylate(PAC), polycarbonate(PC), polyethylene(PE), polymethylmethacrylate(PMMA), polyetheretherketon(PEEK), polyethylenenaphthalate(PEN), polyetherimide(PEI), polyimide(PI), polyamideimide(PAI) and triacetylcellulose(TAC).

And, the base support layer may be a single layer structure, or a multilayer structure of two or more layers consisting of identical or different materials. For example, the base support layer may be a multilayer structure of polyethyleneterephthalate(PET), a multilayer structure formed by coextrusion of polymethylmethacrylate(PMMA)/polycarbonate(PC), or a single layer structure comprising a copolymer of polymethylmethacrylate(PMMA) and polycarbonate(PC).

And, the support base layer may be, if necessary, plasma surface treated, and it may be conducted according to a common method without specific limitations.

And, if the thickness of the support base layer is too thick or thin, problems in terms of surface hardness, impact resistance or folding property may be caused, and thus, it is preferable that the thickness range is appropriately adjusted. For example, the support base layer may have a thickness of 30 to 100 μm, more specifically 50 to 80 μm.

The optical laminate according to one embodiment may further comprise an adhesive layer positioned on one side of the support base layer so as to be opposite to the hard coating layer. The adhesive layer may be an adhesive or pressure sensitive adhesive film, and is not specifically limited as long as it is known in the art. Meanwhile, although the pressure sensitive adhesive film is not specifically limited as long as it is known in the art, a double-sided pressure sensitive adhesive film such as an optically clear adhesive (OCA) film may be used.

The optical laminate having the above explained structure and construction may be prepared by coating a resin composition for forming a hard coating layer on one side of the support base layer, and then, curing to form a hard coating layer; coating a resin composition for forming a primer layer on the hard coating layer, and then, curing to form a primer layer; and, coating a resin composition for forming an anti-finger print layer on the primer layer, and then, curing to form a primer layer. And, before or after applying the hard coating layer on one side of the support base layer, a resin composition for forming a hard coating layer similar or identical to the resin composition for forming the hard coating layer may be coated on the other side of the support base layer and cured to form the lower hard coating layer.

And, before applying the resin composition for forming a primer layer on the hard coating layer, the surface of the hard coating layer may be treated by plasma or corona, thereby improving adhesive force.

In the above explained preparation method of an optical laminate, the composition and weight ratio of polysiloxane, elastic polymer, reactive monomers, and the like included in the resin composition for forming a hard coating layer are as explained above, the composition and content of organic silane compound, and the like included in the resin composition for forming a primer layer are as explained above, and the composition and content of fluorine-containing compound, and the like included in the resin composition for forming an anti-finger print layer are as explained above.

And, the resin composition for forming a hard coating layer, resin composition for forming a primer layer, and resin composition for forming an anti-finger print layer may further comprise initiators, respectively. The initiators may be a photopolymerization or thermal polymerization initiator well known in the art, and the kind is not specifically limited. For example, the photopolymerization initiator may be one or more selected from the group consisting of aryl sulfonium hexafluoroantimonate salt, aryl sulfonium hexafluorophosphate salt, diphenyldiiodonium hexafluorophosphate salt, diphenyldiiodonium hexaantimonate salt, ditolyliodonium hexafluorophosphate salt, and 9-(4-hydroxyethoxyphenyl)cyanthrenium hexafluorophsphate salt, but not limited thereto. The thermal polymerization initiator may comprise one or more selected from the group consisting of 3-methyl-2-butenyltetramethylenesulfonium hexafluoroantimonate, ytterbium trifluoromethanesulfoate, samarium trifluoromethanesulfonate, erbium trifluoromethanesulfonate, dysprosium trifluoromethanesulfonate, lanthanum trifluoromethanesulfonate, tetrabutylphosphonium methanesulfonate, ethyltriphenylphosphonium bromide, benzyldimethylamine, dimethylaminomethylphenol, triethanolamine, N-n-butylimidazole and 2-ethyl-4-methylimidazole, but not limited thereto.

The initiator may be included in the content of 0.1 to 10 wt %, 0.5 to 5 wt % or 1 to 4 wt %, based on the total content (100 wt %) of the composition. If the content of the initiator is less than 0.1 wt %, only surface curing may occur or epoxy curing may not sufficiently occur, and thus, hardness may be low, and if it is greater than 10 wt %, due to rapid curing speed, cracks and delamination may be induced.

The resin composition for forming a hard coating layer, resin composition for forming a primer layer, and resin composition for forming an anti-finger print layer may be used as solvent-free, if there is no process problem, but may optionally further comprise an organic solvent so as to control the viscosity and flowability of the composition during coating and increase coatability of the composition.

In case the organic solvent is further included, as the organic solvent, alcohol-based solvents such as methanol, ethanol, isopropylalcohol, butanol; alkoxy alcohol-based solvents such as 2-methoxyethanol, 2-ethoxyethanol, 1-methoxy propanol; ketone-based solvents such as acetone, methylethylketone, methylisobutyleketone, methylpropylketone, cyclohexanone; ether-based solvents, such as propyleneglycol monopropyl ether, propyleneglycol monomethyl ether, ethyleneglycol monoethyl ether, ethyleneglycol monopropyl ether, ethyleneglycol monobutyl ether, diethyleneglycol monomethyl ether, diethyleneglycol monoethyl ether, diethyleneglycol monopropyl ether, diethyleneglycol monobutyl ether, diethyleneglycol-2-ethylhexyl ether; acetate-based solvents such as propyleneglycol monomethyl ether acetate, ethyleneglycol monoethyl ether acetate, diethyleneglycol monobutyl ether acetate, diethyleneglycol monoethyl ether acetate, and the like; or aromatic solvents such as benzene, toluene, xylene, and the like may be used alone or in combination.

And, the resin composition for forming a hard coating layer, resin composition for forming a primer layer, and resin composition for forming an anti-finger print layer may further comprise an anti-oxidant, surfactant, an anti-yellowing agent, inorganic filler, lubricant, a coating assistant, an anti-foulant, and the like, in addition to the above explained components. And, the content may be controlled in the range where the properties are not deteriorated, and thus, is not specifically limited, but for example, may be 0.1 to 10 wt %, based on total content (100 wt %) of the composition.

For example, the anti-oxidant is used to inhibit an oxidation reaction caused by the polymerization initiator, and may comprise one or more selected from the group consisting of phenolic, phosphate-based, aminic, thioester-based antioxidants, and the like, but not limited thereto. The surfactant may be mono- to di-functional fluorine-based acrylate, fluorine-based surfactant or silicon-based surfactant. Wherein, the surfactant may be included while being dispersed or crosslinked in the crosslinked copolymer. And, as the anti-yellowing agent, a benzophenone-based compound or a benzotriazole-based compound may be mentioned.

The coating of the resin composition for forming a hard coating layer, resin composition for forming a primer layer, and resin composition for forming an anti-finger print layer may be conducted by known method such as die coater, air knife, reverse roll, spray, blade, casting, gravure, spin coating, or bar coating, and the like.

And, after coating each resin composition, a process for curing may be conducted, and the curing may be progressed by thermal curing or photocuring according to a common method. The conditions of heat treatment or light irradiation for thermal curing or photocuring may be appropriately controlled through the control of wavelength region and quantity of light, or heat treatment temperature, and the like according to the kind of initiators.

According to another embodiment of the invention, there is provided a flexible display device including the optical laminate.

The flexible display device may comprise curved, bendable, flexible, rollable or foldable mobile phone, smart phone, touch panel of table PC, wearable devices and displays. According to various examples, the wearable device may comprise at least one of accessary type (for example, watch, ring, bracelet, ankle bracelet, necklace, glasses, contact lens, or head-mounted device (HMD), fabric or cloth-integrated type (for example, electronic clothes), body-attach type (for example, skin pad or tattoo), or bioimplant-type (for example, implantable circuit).

Meanwhile, the flexible display device may be, for example, a liquid crystal display (LCD), a light emission diode (LED) display, an organic light emitting diode (OLED) display, a micro electro mechanical system (MEMS) display, or a rollable display or foldable display.

For example, in the organic light emitting diode (OLED) display, a cover window of the flexible organic light emitting diode display may be positioned at the outermost part of the direction of light or image, and it may be sequentially formed of a cathode supplying electrons, an electron transport layer, an emission layer, a hole transport layer, and an anode supplying holes. And, the organic light emitting diode (OLED) display may further comprise a hole injection layer (HIL) and an electron injection layer (EIL).

In order that the organic light emitting diode (OLED) display functions and works as a flexible display, elastic materials may be used for the cathode and anode, and each constructional components.

For another example of the flexible display device, a rollable display or a foldable display may be mentioned.

Meanwhile, the rollable or foldable display may have various structures according to application field and specific shape, and for example, it may have a structure comprising a cover window, a touch panel, a polarizing plate, a barrier film, a light emission device (OLED device, and the like), a transparent substrate, and the like.

For another example, the flexible display device may be a liquid crystal display comprising one pair of polarizing plates opposite to each other; a thin film transistor, a color filter and liquid crystal cell sequentially laminated between the one pair of polarizing plates; and a backlight unit.

In the display device, the optical laminate may be equipped on the outermost surface of the observer or backlight side of the display panel.

### ADVANTAGEOUS EFFECTS

According to the invention, there are provided an optical laminate that exhibits excellent anti-fouling property and high hardness, and yet, has excellent adhesive force and scratch resistance, and particularly, is not substantially damaged even by repeated bending or folding, and a flexible display device including the same.

And, since the optical laminate exhibits improved bending property, and yet, has excellent flexibility, high hardness and scratch resistance, and particularly, is not substantially damaged even by repeated bending or folding, it can be usefully applied for front panels and display parts of bendable, flexible, rollable or foldable mobile devices, display devices, and instrument panels.

### BRIEF DESCRIPTION OF DRAWINGS

FIG. 1 schematically shows a method of evaluating dynamic bending property.

The invention will be explained in more detail in the following examples. However, these examples are presented only as the illustrations of the invention, and the scope of the invention is not limited thereby.

### PREPARATION EXAMPLE

### Preparation Example 1-1: Preparation of a Resin Composition for Forming an Anti-Finger print layer (AF-1)

1 g of a perfluoro-modified silane compound (product name: KY-185, manufacturing company: Shinetsu, weight average molecular weight: 520), 0.01 g of water, and 100 g of a hydrofluoroether as a fluorine-based solvent (product name: HFE-7200, manufacturing company: Novec) were mixed to prepare a resin composition for forming an anti-finger print layer (AF-1).

### Preparation Example 1-2: Preparation of a Resin Composition for Forming an Anti-Finger Print Layer (AF-2)

0.1 g of perfluoropolyethylene urethane acrylate (product name: AD1700, manufacturing company: SOLVAY, weight average molecular weight: 3000) and 100 g of a hydrofluoroether as a fluorine-based solvent (product name: HFE-7200, manufacturing company: Novec) were mixed to prepare a resin composition for forming an anti-finger print layer (AF-2).

### Preparation Example 1-3: Preparation of a Resin Composition for Forming an Anti-Finger Print Layer (AF-3)

50 g of 3-methacryloxypropyl trimethoxysilane (product name KBM-503 manufacturing company: Shinetsu), 50 g of trimethoxyphenylsilane (product name: phenyltrimethoxysilane, manufacturing company: Aldrich, molecular weight: 198), 1 g of a photoinitiator (Irgacure 127), 400 g of a 2-butanone as an organic solvent and 2 g of perfluoropolyethylene polymethacrylate were mixed to prepare a resin composition for forming an anti-finger print layer (AF-3).

### Preparation Example 1-4: Preparation of a Resin Composition for Forming an Anti-Finger Print Layer (AF-4)

15 g of perfluoropolyethylene urethane acrylate (product name: AD1700, manufacturing company: SOLVAY), 0.7 g of N-2-(aminoethyl)-3-aminopropyl trimethoxysilane and 84.3 g of trifluorotoluene were mixed to prepare a resin composition for forming an anti-finger print layer (AF-4).

### Preparation Example 2: Preparation of a Resin Composition for Forming a Primer Layer (P-1)

1 g of N-2-(aminoethyl)-3-aminopropyl trimethoxysilane, 0.3 g of methyltrimethoxysilane, 100 g of ethanol and 20 g of t-amyl alcohol were mixed to prepare a resin composition for forming a primer layer (P-1).

### Preparation Example 3-1: Preparation of a Resin Composition for Forming a Hard Coating Layer (H-1)

Into a 1000 mL 3-neck flask, 3-glycidoxypropyl trimethoxysilane (GPTMS, KBM-403™, Shinetsu) as a silane monomer, water and toluene were introduced, and stirred (ratio of GPTMS:watertoluene=4 mol:1 mol:3 mol). To the resulting mixed solution, a basic catalyst(TMAH) was added in the amount of 1 part by weight, based on 100 parts by weight of the silane monomers, and reacted at 100° C. for 2 hours to prepare polysiloxane comprising 100 mol % of glycidoxypropyl modified silicon(hereinafter, referred to as ‘GP’) (number average molecular weight: 2,000 g/mol, polydispersity index(PDI): 1.4, glycipropyl equivalent: 6.0 mmol/g).

10 g of the polysiloxane, 3 g of bisphenol A diglycidylether (Merck), 4 g of polycaprolactone diol (Mn: 530, Merck) and 0.3 g of iodinium,(4-methylphenyl)[4-(2-methylpropyl)phenyl]-,hexafluorophosphate(1-), (IGM resins) as an initiator were mixed to prepare a resin composition for forming a hard coating layer (H-1).

### Preparation Example 3-2: Preparation of a Resin Composition for Forming a Hard Coating Layer (H-2)

A resin composition for forming a hard coating layer (H-2) was prepared by the same method as Preparation Example 3-1, except that 8 g of polycaprolactone diol (Mn: 530, Merck) was used instead of 4 g of polycaprolactone diol (Mn: 530, Merck).

### Preparation Example 3-3: Preparation of a Resin Composition for Forming a Hard Coating Layer (H-3)

A resin composition for forming a hard coating layer (H-3) was prepared by the same method as Preparation Example 3-1, except that 6 g of bisphenol A diglycidylether was used instead of 3 g of bisphenol A diglycidylether.

### EXAMPLE

### Example 1

As described in the following Table 1, the compositions respectively prepared in the Preparation Examples were sequentially coated and cured to prepare an optical laminate.

Specifically, on one side of a polyethyleneterephthalate(PET) substrate(support base layer) of 15 cm×20 cm, and thickness of 50 μm, the resin composition for forming a hard coating layer (H-1) prepared in Preparation Example 3 was coated, and then, irradiated by UV (irradiation amount: 400 mJ/cm²) using a UV lamp to photocure, thus forming the lower hard coating layer with a thickness of 80 μm, and on the opposite side of the PET substrate, the resin composition for forming a hard coating layer (H-1) prepared in Preparation Example 3 was coated, and irradiated by UV (irradiation amount: 400 mJ/cm²) using a UV lamp to photocure, thus forming the upper hard coating layer with a thickness of 80 μm.

And then, the upper hard coating layer was surface-treated with plasma, and then, the resin composition for forming a primer layer (P-1) prepared in Preparation Example 2 was coated, and then, photocured at 110° C. for 30 minutes to form a primer layer with a thickness of 30 nm. On the primer layer, the resin composition for forming an anti-finger print layer (AF-1) prepared in Preparation Example 1-1 was coated, and then, photocured at 110° C. for 30 minutes to form an anti-finger print layer with a thickness of 10 nm, thereby preparing an optical laminate.

### Example 2

An optical laminate was prepared by the same method as Example 1, except that the resin composition for forming an anti-finger print layer (AF-2) prepared in Preparation Example 1-2 was used instead of the resin composition for forming an anti-finger print layer (AF-1) prepared in Preparation Example 1-1, and that the lower hard coating layer was not formed.

### Example 3

An optical laminate was prepared by the same method as Example 1, except that the resin composition for forming an anti-finger print layer (AF-2) prepared in Preparation Example 1-2 was used instead of the resin composition for forming an anti-finger print layer (AF-1) prepared in Preparation Example 1-1.

### Comparative Example 1

An optical laminate was prepared by the same method as Example 1, except that the resin composition for forming an anti-finger print layer (AF-2) prepared in Preparation Example 1-2 was used instead of the resin composition for forming an anti-finger print layer (AF-1) prepared in Preparation Example 1-1, and that the primer layer was not formed.

### Comparative Example 2

On one side of a polyethyleneterephthalate(PET) substrate(support base layer) of 15 cm×20 cm, and thickness of 50 μm, the resin composition for forming a hard coating layer (H-1) prepared in Preparation Example 3 was coated, and then, irradiated by UV (irradiation amount: 400 mJ/cm²) using a UV lamp to photocure, thus forming the lower hard coating layer with a thickness of 80 μm, and on the opposite side of the PET substrate, the resin composition for forming an anti-finger print layer (AF-3) prepared in Preparation Example 1-3 was coated, and irradiated by UV (irradiation amount: 400 mJ/cm²) using a UV lamp to photocure, thus forming an anti-finger print layer with a thickness of 10 nm, thereby preparing an optical laminate.

### Comparative Example 3

An optical laminate was prepared by the same method as Example 1, except that the resin composition for forming an anti-finger print layer (AF-4) prepared in Preparation Example 1-4 was used instead of the resin composition for forming an anti-finger print layer (AF-1) prepared in Preparation Example 1-1, and that the primer layer was not formed.

### Comparative Example 4

An optical laminate was prepared by the same method as Example 1, except that the resin composition for forming a hard coating layer (H-2) prepared in Preparation Example 3-2 was used instead of the resin composition for forming a hard coating layer (H-1) prepared in Preparation Example 3-1.

### Comparative Example 5

An optical laminate was prepared by the same method as Example 1, except that the resin composition for forming a hard coating layer (H-3) prepared in Preparation Example 3-3 was used instead of the resin composition for forming a hard coating layer (H-1) prepared in Preparation Example 3-1.

TABLE 1

| | Example | Example | Example | Comparative | Comparative | Comparative | Comparative | Comparative |
|---|---|---|---|---|---|---|---|---|
| | 1 | 2 | 3 | Example 1 | Example 2 | Example 3 | Example 4 | Example 5 |
| Anti-finger | Preparation | Preparation | Preparation | Preparation | — | Preparation | Preparation | Preparation |
| print layer | Example 1-1 | Example 1-2 | Example 1-2 | Example 1-2 | | Example 1-4 | Example 1-1 | Example 1-1 |
| | (AF-1) | (AF-2) | (AF-2) | (AF-2) | | (AF-4) | (AF-1) | (AF-1) |
| Primer layer | Preparation | Preparation | Preparation | — | — | — | Preparation | Preparation |
| | Example 2 | Example 2 | Example 2 | | | | Example 2 | Example 2 |
| | (P-1) | (P-1) | (P-1) | | | | (P-1) | (P-1) |
| Upper hard | Preparation | Preparation | Preparation | Preparation | Preparation | Preparation | Preparation | Preparation |
| coating layer | Example 3-1 | Example 3-1 | Example 3-1 | Example 3-1 | Example 1-3 | Example 3-1 | Example 3-2 | Example 3-3 |
| | (H-1) | (H-1) | (H-1) | (H-1) | (AF-3) | (H-1) | (H-2) | (H-3) |
| Support base | PET | PET | PET | PET | PET | PET | PET | PET |
| layer | | | | | | | | |
| Lower hard | Preparation | — | Preparation | Preparation | Preparation | Preparation | Preparation | Preparation |
| coating layer | Example 3-1 | | Example 3-1 | Example 3-1 | Example 3-1 | Example 3-1 | Example 3-2 | Example 3-3 |
| | (H-1) | | (H-1) | (H-1) | (H-1) | (H-1) | (H-2) | (H-3) |

### Experimental Example

For the optical laminates prepared in Examples and Comparative Examples, the properties were measured as follows, and the results were shown in the following Table 2.

### 1. Measurement of Water Contact Angle before and after Steel Wool Test

For each anti-finger print layer of Examples and Comparative Examples (in the case of Comparative Example 2, the upper hard coating layer), a water contact angle was measured using a contact angle analyzer (CAX-150). When measuring a contact angle, the size of one water drop was 3 [symbol] , and in order to confirm the uniformity of coating, contact angles of 5 points were measured per one coated sample and then averaged, and the result was described in water contact angle before steel wool test in the following Table 2.

And then, after 1000 times reciprocating abrasion of steel wool(#0000) under load of 500 g on the surface of the anti-finger print layer, a water contact angle was measured for the surface of the anti-finger print layer by the same method as explained above, and the result was described in water contact angle after steel wool test in the following Table 2.

### 2. Measurement of Coefficient of Friction before and after Steel Wool Test

For each anti-finger print layer of Examples and Comparative Examples (in the case of Comparative Example 2, the upper hard coating layer), coefficient of static friction was measured according to ASTM D1894 using a friction tester (Toyoseiki, Model TR type), and the result was described in coefficient of friction before steel wool test in the following Table 2.

And then, after 1000 times reciprocating abrasion of steel wool (#0000) under load of 500 g on the surface of the anti-finger print layer, coefficient of static friction was measured according to ASTM D1894 for the surface of the anti-finger print layer, and the result was described in coefficient of friction after steel wool test in the following Table 2.

### 3. Evaluation of Scratch Resistance

After 1000 times reciprocating abrasion with steel wool(#0000) under load of 500 g on the surface of each anti-finger print layer of Examples and Comparative Examples (in the case of Comparative Example 2, the upper hard coating layer), it was confirmed with the naked eye whether or not scratch was generated, and it was judged as “O.K.” when scratch of 3 mm or less was generated, and as “N.G.” when scratch greater than 3 mm was generated.

### 4. Evaluation of Eraser Abrasion

After 1500 times reciprocating abrasion of Minoan eraser under load of 500 g on the surface of each anti-finger print layer of Examples and Comparative Examples (in the case of Comparative Example 2, the upper hard coating layer), it was confirmed with the naked eye whether or not the coating film was abraded (scratch, Haze), and it was judged as “O.K.” when there was no deformation, and as “N.G.” when abrasion deformation was generated.

### 5. Evaluation of Dynamic Bending Property

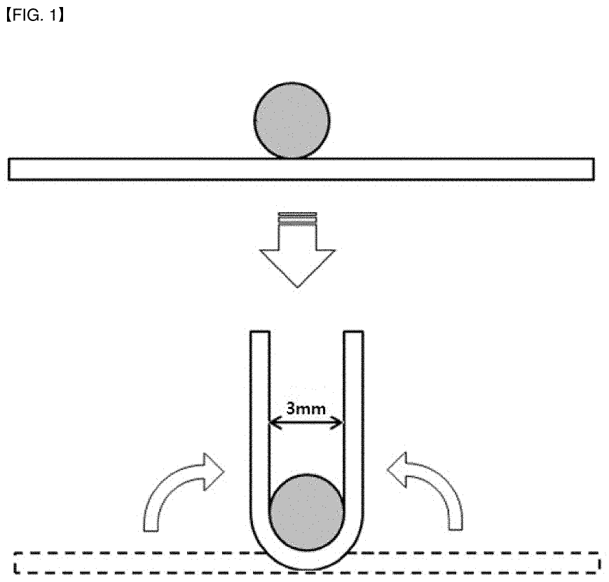

FIG. 1 schematically shows a method of evaluating dynamic bending property for the optical laminate according to one example of the invention.

The optical laminate was laser cut to a size of 80×140 mm so as to minimize fine cracks at the edge. On a measuring device, the laser cut film was put, and with the lower hard coating layer(in the case of Example 2, support base layer) being inside, and with a distance between folded parts (inner diameter of curvature) being 3 mm, continuous movement of folding both sides of the film at 90 degree to the bottom surface and unfolding was repeated 200,000 times at room temperature (film folding speed: one time per 1.5 seconds), and dynamic bending property was evaluated according to the following standard.

O.K.: No crack generated

N.G.: Crack generated

TABLE 2

| | | | | | Comparative | Comparative | Comparative | Comparative | Comparative |
|---|---|---|---|---|---|---|---|---|---|
| | | Example 1 | Example 2 | Example 3 | Example 1 | Example 2 | Example 3 | Example 4 | Example 5 |
| Water contact | Before steel | 115° | 115° | 110° | 110° | 80° | 112° | 111° | 111° |
| angle | wool evaluation | | | | | | | | |
| | After steel | 107° | 110° | 103° | 75° | 65° | 75° | 103° | 75° |
| | wool evaluation | | | | | | | | |
| Coefficient | Before steel | 0.09 | 0.09 | 0.05 | 0.10 | 0.40 | 0.09 | 0.09 | 0.08 |
| of friction | wool evaluation | | | | | | | | |
| | After steel | 0.24 | 0.22 | 0.18 | 0.41 | 0.70 | 0.45 | 0.25 | 0.40 |
| | wool evaluation | | | | | | | | |

| | | | | | | | | |
|---|---|---|---|---|---|---|---|---|
| Scratch resistance | O.K. | O.K. | O.K. | N.G. | N.G. | N.G. | N.G. | N.G. |
| Eraser abrasion degree | O.K. | O.K. | O.K. | N.G. | N.G. | N.G. | N.G. | N.G. |
| Dynamic bending property | O.K. | O.K. | O.K. | O.K. | O.K. | O.K. | O.K. | O.K. |

According to Table 2, it was confirmed that since each optical laminate of Examples 1 to 3 sequentially comprise a hard coating layer, a primer layer and an anti-finger print layer, and before and after a steel wool test, has a change in a water contact angle of 10° or less, and a change in a coefficient of friction of 0.2 or less, it exhibits excellent scratch resistance and eraser abrasion, and exhibits dynamic bending property to such a degree that cracks are not generated even if continuous movement of folding and unfolding was repeated 200,000 times.

Meanwhile, it was confirmed that in the case of the optical laminates of Comparative Examples, since a primer layer is not included, or a hard coating layer having a composition different from the invention is used, adhesion between the upper hard coating layer and anti-finger print layer is weak, and thus, scratch resistance and abrasion resistance are inferior, and change in water contact angle and change in coefficient of friction before and after steel wool test are large.

1. An optical laminate comprising: a hard coating layer comprising polysiloxane; a primer layer; and an anti-finger print layer comprising a fluorine-containing compound,
wherein a water contact angle on a surface of the anti-finger print layer is 100° or more,
before and after 1000 times reciprocating abrasion of steel wool under load of 500 g on the surface of the anti-finger print layer, a change in the water contact angle of the surface of the anti-finger print layer is 10° or less, and
before and after 1000 times reciprocating abrasion of steel wool under load of 500 g on the surface of the anti-finger print layer, a change in a coefficient of friction of the surface of the anti-finger print layer is 0.2 or less.

2. The optical laminate according to claim 1,
wherein the polysiloxane comprises 70 mol % or more of a repeat unit comprising an epoxy group-containing functional group.

3. The optical laminate according to claim 2,
wherein the epoxy group-containing functional group is at least one group selected from the group consisting of an alicyclic epoxy group and a functional group represented by Chemical Formula 1: 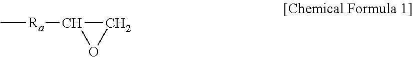
in the Chemical Formula 1,
Rₐ is a substituted or unsubstituted C1-6 alkylene group, a substituted or unsubstituted C2-20 alkenylene group, a substituted or unsubstituted C2-20 alkynylene group, —R_{b}—CH═CH—COO-R_{c}—, —R_{d}—OCO—CH═CH—Rₑ—, —R_{f}OR_{g}—, —RₕCOORᵢ—, or —RⱼOCORₖ—, and
R_{b} to Rₖ are each independently, a single bond; or a substituted or unsubstituted C1-6 alkylene group.

4. The optical laminate according to claim 2,
wherein the polysiloxane has an epoxy group-containing functional group equivalent of 3.0 to 6.3 mmol/g.

5. The optical laminate according to claim 1,
wherein the polysiloxane has a weight average molecular weight of 1,000 to 50,000 g/mol, a number average molecular weight of 1,000 to 10,000 g/mol and a polydispersity index of 1.0 to 10.0.

6. The optical laminate according to claim 1,
wherein the hard coating layer further comprises, based on 100 parts by weight of the polysiloxane, 20 to 80 parts by weight of an elastic polymer.

7. The optical laminate according to claim 6,
wherein the elastic polymer comprises polycaprolactone polyol.

8. The optical laminate according to claim 1,
wherein the primer layer comprises an organic silane compound having at least one organic functional group selected from the group consisting of an epoxy group, a (meth)acryloxy group, a mercapto group, an amino group, a vinyl group and a ureido group.

9. The optical laminate according to claim 8,
wherein the organic silane compound comprises at least one silane compound selected from the group consisting of 2-(3,4-epoxycyclohexyl)-ethyltrimethoxysilane, 3-glycidoxypropyl trimethoxysilane, 3-glycidoxypropyl methyldiethoxysilane, 3-glycidoxypropyl triethoxysilane, glycidoxypropyl methyldimethoxysilane, N-2-(aminoethyl)-3-aminopropyl methyldimethoxysilane, N-2-(aminoethyl)-3-aminopropyl trimethoxysilane, N-2-(aminoethyl)-3-aminopropyl triethoxysilane, 3-aminopropyl trimethoxysilane, 3-aminopropyl triethoxysilane, 3-uriedo propyl trimethoxysilane, 3-uriedo propyl trialkoxysilane, vinyl trimethoxysilane, vinyl triethoxysilane, methacryloxy trimethoxysilane, methacryloxy triethoxysilane, N-phenyl-γ-aminopropyl trimethoxy silane, and mercaptopropyl trimethoxysilane.

10. The optical laminate according to claim 8,
wherein the primer layer further comprises at least one organic silane compound selected from the group consisting of methyltrimethoxysilane, methyltriethoxysilane, ethyltrimethoxysilane, ethyltriethoxysilane, propyltrimethoxysilane, propyltriethoxysilane, and methyltributoxysilane.

11. The optical laminate according to claim 1,
wherein the fluorine-containing compound comprises at least one compound selected from the group consisting of a perfluoro polyether compound, an oxyperfluoroalkylene group-containing compound, a fluoro-modified silane compound, and a fluoroalkyl group-containing compound.

12. The optical laminate according to claim 1,
wherein a thickness ratio of the primer layer and the anti-finger print layer is 1:0.01 to 10,000.

13. The optical laminate according to claim 1,
wherein the hard coating layer, the primer layer and the anti-finger print layer are sequentially laminated, and
the optical laminate further comprises a support base layer positioned on one side of the hard coating layer so as to be opposite to the primer layer.

14. The optical laminate according to claim 13,
further comprising an adhesive layer positioned on one side of the support base layer so as to be opposite to the hard coating layer.

15. A flexible display device including the optical laminate according to claim 1.
